(19) United States
(12) Patent Application Publication
(10) Pub. No.: US 2026/0142873 A1
(43) Pub. Date: May 21, 2026

(54) DYNAMICALLY PROGRAMMING MATERIAL TARGET STATES PER-DEVICE

(71) Applicant: Cisco Technology, Inc., San Jose, CA (US)

(72) Inventors: Jeffrey Yi Dar Lo, Cupertino, CA (US); Daniel Eric Talayco, Mountain View, CA (US); Robert Stephen Rodgers, Mountain View, CA (US); Kyle Andrew Donald Mestery, Woodbury, MN (US); Thomas John Giuli, Mountain View, CA (US); Michael Dodd, Fremont, CA (US); Pradeep B. Chulliyan, Belmont, CA (US)

(21) Appl. No.: 19/250,013

(22) Filed: Jun. 25, 2025

Related U.S. Application Data
(60) Provisional application No. 63/722,584, filed on Nov. 19, 2024.

(51) Int. Cl. H04L 41/08

(52) U.S. Cl. CPC H04L 41/08

(57) ABSTRACT

In some embodiments, a device, includes a processor, and a memory communicatively coupled to the processor, wherein the memory includes a material target state programming logic. The logic is configured to receive a material target state, initiate a programming sequence associated with the material target state, execute individual configuration operations, receive a programming outcome report, compile a programming status report, and transmit the programming status report.

### CROSS-REFERENCE TO RELATED APPLICATION

This application claims the benefit of priority to U.S. Provisional Application No. 63/722,584, filed Nov. 19, 2024, the disclosure of which is incorporated by reference herein in its entirety.

The present disclosure relates to communication networks. More particularly, the present disclosure relates to realizing material target states via abstract network state input.

### BACKGROUND

A network fabric is an interconnected architecture of switches and routers, often found in data centers or enterprise environments, which forms a grid that enables efficient, high-speed data transfer. By linking devices directly or in closely connected layers, a network fabric facilitates seamless communication and is designed to provide a flexible and scalable infrastructure for data centers and cloud environments. This interconnectedness allows data to move quickly between various components, such as servers and storage devices, making it especially suited for environments that handle large amounts of data or require rapid processing. A common topology used within network fabrics is a leaf-spine system, where “spine” switches act as the network backbone connecting to all “leaf” switches, which in turn connect to servers and other end devices.

Cloud controllers add a layer of efficiency and centralization to network fabrics, allowing for the remote management of network resources and the automation of complex networking tasks. A cloud controller for a network fabric can be a centralized system that manages and coordinates the various networking components within a cloud environment, often configured as a software-based management tool accessible through the internet. Its role can be to oversee the network fabric, providing a high-level, centralized view of all activity and performance within the network. This comprehensive view allows the cloud controller to make real-time adjustments to optimize data flow, and many routine tasks, such as balancing network traffic or troubleshooting, can be automated, reducing the need for manual intervention.

The integration of demanding workloads, such as those associated with artificial intelligence (AI), into network fabrics leverages the low-latency, high-throughput nature of these interconnected systems. AI applications often rely on fast, constant access to large data sets and powerful computational resources, which network fabrics facilitate by creating efficient pathways between components. However, integrating these advanced workloads comes with significant challenges. The complexity of configuring specific networking requirements can be daunting, and handling massive data transfers and low-latency demands can strain even well-designed network fabrics. Furthermore, scaling the network to accommodate expanding application demands can lead to performance issues, making the management of modern network fabrics a challenging endeavor.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a network fabric with network devices in accordance with various embodiments of the disclosure;

FIG. 2 is a conceptual illustration of transferring data traffic between devices in a network in accordance with various embodiments of the disclosure;

FIG. 3 is a schematic block diagram of an example leaf-spine network fabric in accordance with various embodiments of the disclosure;

FIG. 4 is a conceptual network diagram of various environments that a material target state programming logic may operate, in accordance with various embodiments of the disclosure;

FIG. 5 is a conceptual timing diagram for programming a switch with material target states via a cloud controller in accordance with various embodiments of the disclosure;

FIG. 6 is a flowchart depicting a process for managing a material target state programming sequence, in accordance with various embodiments of the disclosure;

FIG. 7 is a flowchart depicting a process for executing material target state programming, in accordance with various embodiments of the disclosure;

FIG. 8 is a flowchart depicting a process for applying configuration changes based on a material target state, in accordance with various embodiments of the disclosure;

FIG. 9 is a flowchart depicting a process for orchestrating a material target state deployment and rollback, in accordance with various embodiments of the disclosure;

FIG. 10 is a conceptual block diagram of a device suitable for configuration with a material target state programming logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DESCRIPTION OF EXAMPLE EMBODIMENTS

### Overview

In some embodiments, a device, includes a processor, and a memory communicatively coupled to the processor, wherein the memory includes a material target state programming logic. The logic is configured to receive a material target state, initiate a programming sequence associated with the material target state, execute individual configuration operations, receive a programming outcome report, compile a programming status report, and transmit the programming status report.

In some embodiments, a method of dynamically programming a material target state includes determining a network target state, generating a material target state based on the network target state, transmitting the material target state, receiving a status report associated with the material target state, and determining the presence of one or more reported errors within the status report.

### Example Embodiments

In response to the issues described above, devices and methods are discussed herein that relates to the challenge of taking a configuration from a cloud controller, such as in a material target state (MTS) form, and reliably programming it into a fabric of network devices. This process can present a number of challenges, which may include communicating the configuration to the various fabric devices, programming the configuration onto the devices themselves, safely rolling back any errors that occur during the programming process, and accurately reporting those errors back to the controller. These challenges can be further compounded in embodiments where a configuration change is intended to be fabric-wide, as a programming failure on even a single device can impact the consistency and operational integrity of the entire network fabric.

This general challenge of configuration management can be exacerbated by the architecture of certain modern, Linux-based network operating systems, such as Sonic. These operating systems may not have the ability to coalesce all configuration settings into a single file and may lack a traditional, transactional “load replace” model for applying changes atomically. Instead, the actual configuration on such a device may be a mixture of individual set operations and commands directed at different, independent software subsystems, such as FRR for routing. This non-coalesced and non-transactional nature makes the process of applying a new configuration, and more importantly, safely rolling it back upon failure, a significantly more complex and error-prone problem to solve compared to traditional network operating systems

In various embodiments, a network target state (NTS) may represent a high-level, abstract model of the desired configuration or operational state for an entire network fabric or a group of devices within it. The NTS can serve as the authoritative source of truth, defining the intended outcome of a configuration change without specifying the exact, device-specific commands required to achieve that outcome. For example, an NTS might define which virtual networks certain endpoints should belong to or what quality of service policies should apply to a particular class of traffic. This layer of abstraction allows network administrators or automation systems to manage the network based on intent rather than needing to handle the intricacies of each individual device's command-line interface or configuration syntax.

The content of the NTS can be derived from various sources and may encompass a wide range of information. In some embodiments, the NTS may be defined manually by a user, such as a network administrator, through a graphical user interface or a policy definition language. In certain other embodiments, the NTS could be determined dynamically by a higher-level orchestration system in response to changing application requirements or network conditions. The data within the NTS may include, but is not limited to, tenant requirements, service level agreements, security policies, and abstract connectivity models that the underlying physical infrastructure is expected to realize.

The NTS can function as the primary input to a central controller or management system, which uses it to begin the process of deploying configuration changes. The controller's logic can be configured to process the abstract NTS and translate it into one or more concrete, device-specific configurations. A single modification to the NTS, which might represent a fabric-wide policy change, could result in the generation of many distinct instructions for each of the various devices that make up the fabric. In this way, the NTS enables scalable, intent-based management of a complex network environment from a single point of control.

A material target state (MTS) may be a concrete, device-specific set of configuration instructions that is generated by a central controller based on the high-level network target state. The MTS can represent the actual configuration files or commands to be run on a particular network device to align its state with the desired NTS. In many embodiments, the MTS is the data artifact that is transmitted from a cloud controller to an on-device agent for execution. The MTS serves to bridge the gap between the abstract intent of the NTS and the practical, actionable commands that a network device can interpret and apply to its internal configuration.

In a number of embodiments, the format and content of the MTS can be highly dependent on the target network device, particularly its operating system. While in some cases the MTS may be a simple, declarative configuration file, in other embodiments it may comprise a procedural script. A procedural MTS can contain a sequence of batch or individual operations that an agent must execute in a specific order. This approach may be utilized for devices with operating systems that lack robust transactional configuration capabilities, as it effectively allows the controller to simulate a transactional change by dictating the precise sequence of steps and checks required to safely apply the configuration.

In further embodiments, the concept of the MTS can extend beyond initial configuration application to include error handling and rollback procedures. When a programming failure is reported by an agent, a controller can generate and transmit a new rollback MTS. From the agent's perspective, this rollback MTS may be treated like any other MTS, but its contents are designed to revert the device's configuration to a previous, known-good state or a minimal safe state. This use of the MTS as a universal mechanism for both applying and reverting changes simplifies the logic required on the agent, as it does not need to retain state or manage complex rollback procedures itself; it can simply execute the MTS provided by the controller.

Within network fabric environments, a leaf and spine system is a network topology commonly used within the network fabric to ensure efficient, high-speed data transfer across a data center. In this setup, the “spine” switches are positioned as the backbone of the network, connecting to all “leaf” switches, which in turn connect directly to servers and other end devices. Unlike traditional hierarchical networking, where data may travel through multiple layers, a leaf and spine system can provide direct paths to any destination within the network fabric. This design may minimize bottlenecks, reduce latency, and allow the network to scale horizontally. In other words, adding more spine switches or leaf nodes can increase capacity without degrading performance. By connecting every leaf switch to each spine switch, the system can maintain fast and consistent data flow, making it an ideal framework for a network fabric that supports large-scale, data-intensive applications, such as, for example, AI applications.

A cloud controller for a network fabric is a centralized system that manages and coordinates the various networking components within a cloud environment. It can act as the “brain” for a network, ensuring that all parts work together seamlessly. In many embodiments, the cloud controller, can be configured as a software-based management tool accessible through the internet, allowing IT teams to manage and control the network remotely. Its role can be to oversee the network fabric, providing a high-level, centralized view of all the activity and performance within the network. With this comprehensive view, the cloud controller can make real-time adjustments to optimize data flow across the network fabric. For example, if one part of the network becomes congested, the controller can identify less busy routes and reroute data to maintain fast, uninterrupted performance.

In a number of embodiments, a cloud controller for a network fabric can simplify management significantly. Without it, each device would need to be configured and monitored individually, which would be complex and time-intensive, especially as the network grows. The controller may also enable scalability by automatically integrating new devices or resources into the network fabric as they're added. Additionally, many routine tasks, such as balancing network traffic or troubleshooting, can be automated, reducing the need for manual intervention and making network management much faster and more efficient.

In a variety of embodiments, an AI-focused network fabric can include a cloud-managed solution designed to simplify the deployment and management of AI infrastructure for enterprises. It can integrate pre-existing network resources with various graphical processing units (GPUs) and data processing units (DPUs), network switches, optics-based devices, specialized data storage, and other AI Enterprise software, forming a cohesive stack aimed at facilitating generative AI applications. This integration can enable organizations to manage their AI infrastructure's lifecycle from design to deployment and ongoing operations, all through a centralized cloud platform.

In more embodiments, an AI-focused network fabric system can offer AI-native capabilities, including design-before-you-buy tools, comprehensive guidance, and plug-and-play deployment, all managed through the cloud. It may further include assertion-based monitoring to promptly identify and address issues, ensuring efficient operation of AI infrastructure. In this way, an AI-focused network fabric can enable enterprises to distribute AI workloads across various business needs and use cases, streamlining the AI adoption process.

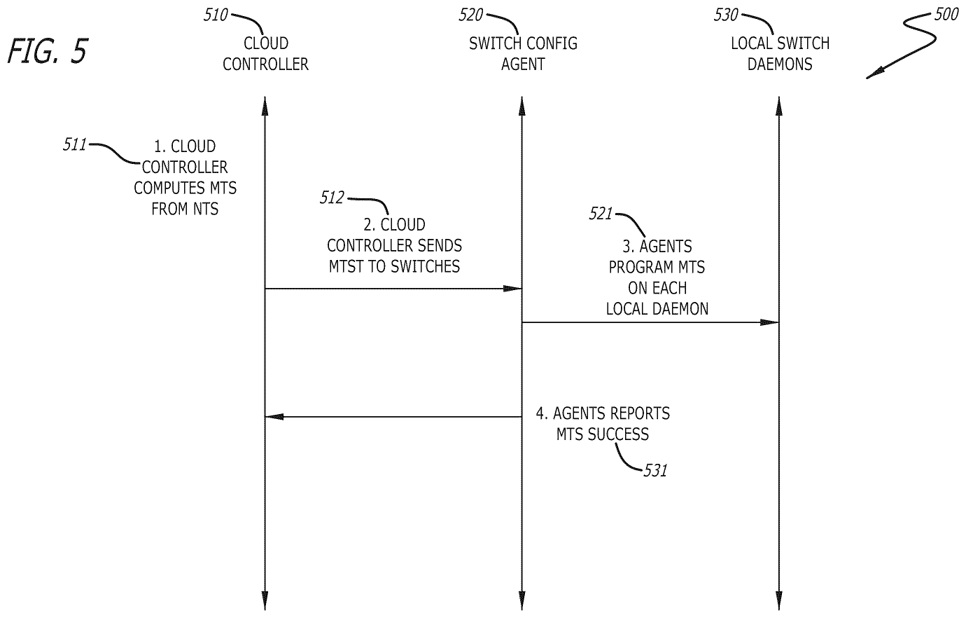

As those skilled in the art will recognize, the problem being solved relates to how configuration is taken from a cloud controller in MTS form (material target state) and program it into a fabric of network devices. The challenge is around both communicating the configuration to the fabric devices, programming the config on the devices, rolling back any errors which happen, and reporting errors back to the controller. In some embodiments, the idea can include explicitly programming a switch with MTS via a cloud controller, and handling errors in an appropriate matter. Since configuration at the ETS and NTS level may be fabric wide, it can also take into account failures on devices which impact the entire fabric. See the embodiment depicted in FIG. 5 below for an example. When failures occur, the agent can report those failures. The cloud controller will then determine the failure and calculate if the error was due to translation from NTS to MTS, or a legitimate error with the device itself.

For rollback with multiple agents, the cloud controller may need to rollback changes on other switches other than the one which had the error itself. For example, consider a change to the underlying EVPN fabric which results in a failure on a certain switch. If that happens, the cloud controller can issue rollback messages to all the devices in the fabric with new MTS to apply. In essence, the rollback becomes new MTS as far as the agent is concerned. T his means the agent doesn't need to retain state for rollbacks after a successful state application, as it relies on the cloud controller to tell it to rollback via new MTS.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams /d/ or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

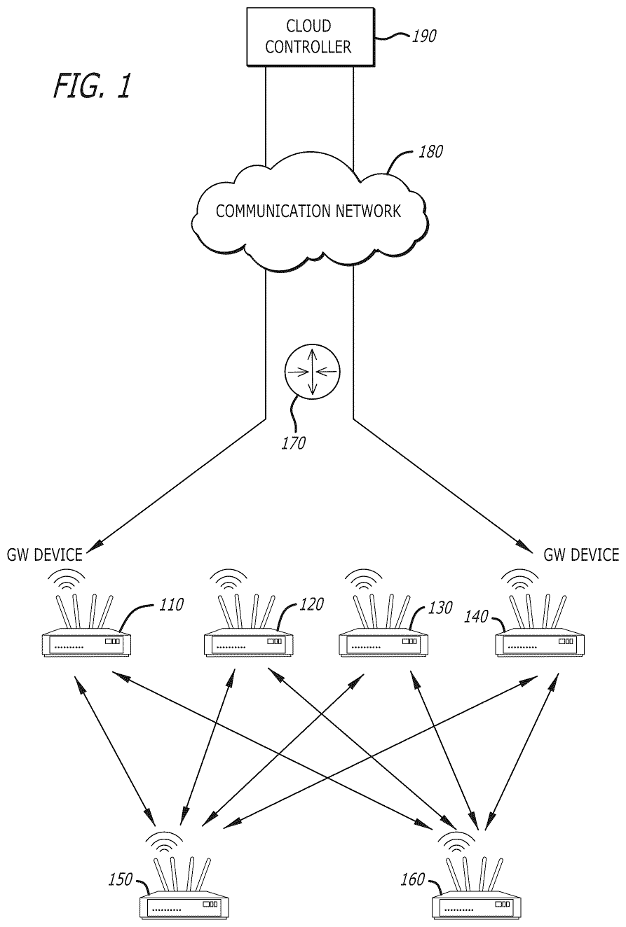

Referring to FIG. 1, a conceptual illustration of a network fabric with network devices in accordance with various embodiments of the disclosure is shown. The system can include a first gateway device 110, a second gateway device 120, a third gateway device 130, a fourth gateway device 140, a first network device 150, a second network device 160, a router 170, a communication network 180, and a cloud controller 190. In various embodiments, this arrangement can represent a typical network fabric, where each device may act as a node within a larger web of interconnected devices, which can enable efficient data flow across the infrastructure.

In many embodiments, the cloud controller 190 can serve as a centralized system that manages and coordinates the various components within the network fabric. The cloud controller 190 may be configured to oversee the network, providing a high-level view of performance and activity. In some embodiments, the cloud controller 190 can add a layer of management by overseeing traffic flow, device discovery, and data forwarding. This centralized control can allow the cloud controller 190 to monitor performance, identify potential bottlenecks, and optimize data routes for efficient operation.

The first gateway device 110, the second gateway device 120, the third gateway device 130, the fourth gateway device 140, the first network device 150, and the second network device 160 may be interconnected with one another, creating a dynamic and resilient structure. This structure can support a high degree of scalability and redundancy, making it suitable for environments that require constant, high-speed data transfers. In many embodiments, each of these devices may have one or more ports, where each port can have one or more interfaces or links connected to other devices in the fabric.

In some embodiments, the first gateway device 110, the second gateway device 120, the third gateway device 130, and the fourth gateway device 140 may facilitate communication between the internal network fabric and the external cloud controller 190. These gateway devices can be connected to the cloud controller 190 by way of the router 170 and the communication network 180. The first gateway device 110, the second gateway device 120, the third gateway device 130, and the fourth gateway device 140 may function as exit nodes for the network fabric. In certain embodiments, the communication network 180 can be the internet.

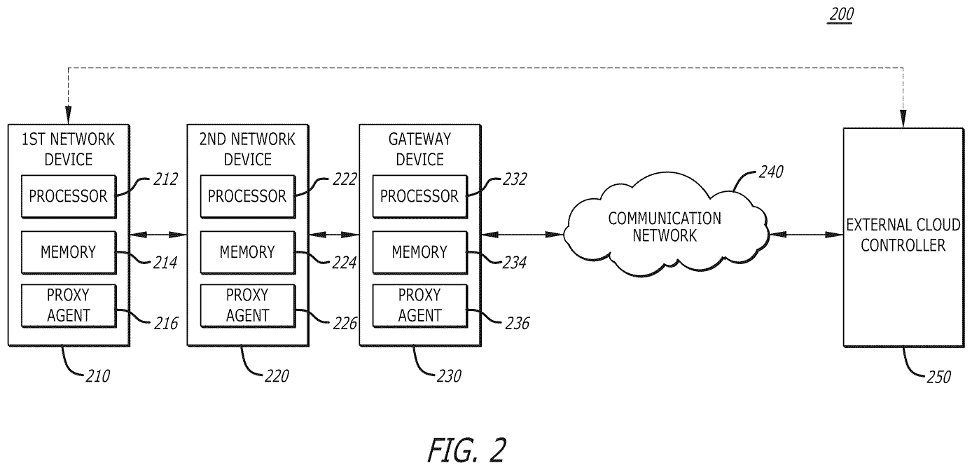

Although a specific embodiment for a network fabric for carrying out the various steps, processes, methods, and operations described herein is discussed with respect to FIG. 1, any of a variety of systems and/or processes may be utilized in accordance with embodiments of the disclosure. For example, the first gateway device 110, the second gateway device 120, the third gateway device 130, and the fourth gateway device 140 may be physical routers, while the first network device 150 and the second network device 160 could be network switches. The elements depicted in FIG. 1 may also be interchangeable with other elements of FIGS. 2-10 as required to realize a particularly desired embodiment.

Referring to FIG. 2, a conceptual illustration of transferring data traffic between devices in a network in accordance with various embodiments of the disclosure is shown. The network 200 may include a first network device 210, a second network device 220, a gateway device 230, a communication network 240, and an external cloud controller 250. In the embodiment shown, the first network device 210 can be connected to the second network device 220, which in turn may be connected to the gateway device 230. The gateway device 230 can be connected to the external cloud controller 250 by way of the communication network 240.

In many embodiments, each device can include a processor, a memory, and a proxy agent. For instance, the first network device 210 may comprise a first processor 212, a first memory 214, and a first proxy agent 216. Similarly, the second network device 220 can include a second processor 222, a second memory 224, and a second proxy agent 226, while the gateway device 230 can include a third processor 232, a third memory 234, and a third proxy agent 236.

The first proxy agent 216, second proxy agent 226, and third proxy agent 236 may facilitate a method of proxying that enables data to flow smoothly between devices, even when direct connections are not available to a final destination. By employing proxy agents, each device within a network fabric can act as a temporary relay point for data, forwarding traffic to the next closest device in a series of hops. This setup can ensure resilience and flexibility within the fabric, as data can be routed through alternative nodes if a direct path is unavailable or becomes congested, which may maintain consistent data flow across the network.

This proxying functionality can be utilized by the external cloud controller 250 to maintain centralized oversight and efficient data management. For example, the first network device 210 may need to communicate with the external cloud controller 250 but may lack a direct connection. In such a circumstance, the first network device 210 may transmit a connection request to the second network device 220, which can forward the request to the gateway device 230. The gateway device 230 can establish a connection with the external cloud controller 250, allowing the first network device 210 to establish a logical connection with the external cloud controller 250. In this way, the gateway device 230 can forward incoming data traffic from the second network device 220 to the external cloud controller 250, and the second network device 220 can forward incoming data traffic from the first network device 210 to the gateway device 230.

Although a specific embodiment for transferring data traffic between devices in a network for carrying out the various steps, processes, methods, and operations described herein is discussed with respect to FIG. 2, any of a variety of systems and/or processes may be utilized in accordance with embodiments of the disclosure. For example, the data traffic may be forwarded between devices using various protocols such as, but not limited to, Internet Protocol Link Local Address (IP LLA) or Remote Procedure Calls (RPC). The elements depicted in FIG. 2 may also be interchangeable with other elements of FIGS. 1 and 3-10 as required to realize a particularly desired embodiment.

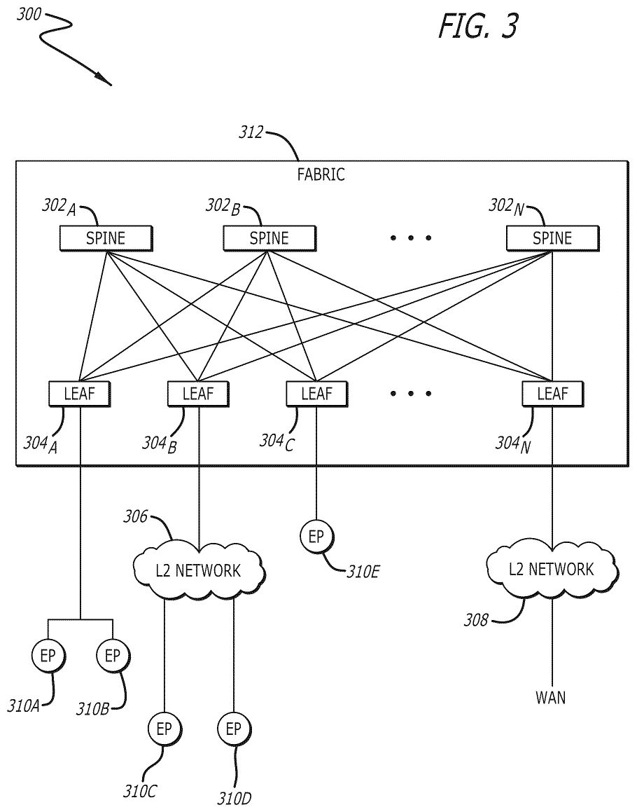

Referring to FIG. 3, a schematic block diagram of an example leaf-spine network fabric in accordance with various embodiments of the disclosure is shown. The example architecture 300 can be implemented within a network fabric 312 and may include one or more spine switches, such as a first spine switch 302A, a second spine switch 302B, and up to an Nth spine switch 302N. The architecture 300 may also include one or more leaf switches, such as a first leaf switch 304A, a second leaf switch 304B, a third leaf switch 304C, and up to an Nth leaf switch 304N. In a leaf-spine topology, the spine switches may be positioned as the backbone of the network, connecting to all of the leaf switches.

In many embodiments, the spine switches, such as the first spine switch 302A and the second spine switch 302B, can be configured as L3 switches that form the core of the network fabric 312. By connecting every leaf switch to each spine switch, this design can minimize bottlenecks, reduce latency, and allow the network to scale horizontally by adding more spine or leaf switches. The spine switches can support various high-speed capabilities and may be configured with one or more high-speed Ethernet ports.

In a number of embodiments, the leaf switches, such as the first leaf switch 304A and the second leaf switch 304B, may reside at the edge of the network fabric 312. Leaf switches can include fabric ports that may provide uplinks to the spine switches, and access ports that can provide connectivity for devices, hosts, endpoints, or external networks to the network fabric 312. In some embodiments, the leaf switches may be responsible for routing or bridging various packets and applying network policies. It is also contemplated that the leaf switches can contain virtual switching functionalities, such as a virtual tunnel endpoint (VTEP) function.

In further embodiments, various endpoints may connect to the network fabric 312 via the leaf switches. For example, a first endpoint 310A and a second endpoint 310B can connect directly to the first leaf switch 304A. In certain embodiments, endpoints may connect through an intermediate network, such as a third endpoint 310C and a fourth endpoint 310D connecting to the second leaf switch 304B via a first L2 network 306. A fifth endpoint 310E may connect directly to the third leaf switch 304C. Additionally, external networks, such as a wide area network (WAN), can connect to the network fabric 312 through the leaf switches, as shown by the connection to the Nth leaf switch 304N via a second L2 network 308. The endpoints, such as the first endpoint 310A, can include any communication device, such as a computer, a server, a switch, or a router.

Although a specific embodiment for a leaf-spine network fabric for carrying out the various steps, processes, methods, and operations described herein is discussed with respect to FIG. 3, any of a variety of systems and/or processes may be utilized in accordance with embodiments of the disclosure. For example, in addition to a wide area network (WAN), a storage area network (SAN) could also be connected to one of the leaf switches. The elements depicted in FIG. 3 may also be interchangeable with other elements of FIGS. 1-2 and 4-10 as required to realize a particularly desired embodiment.

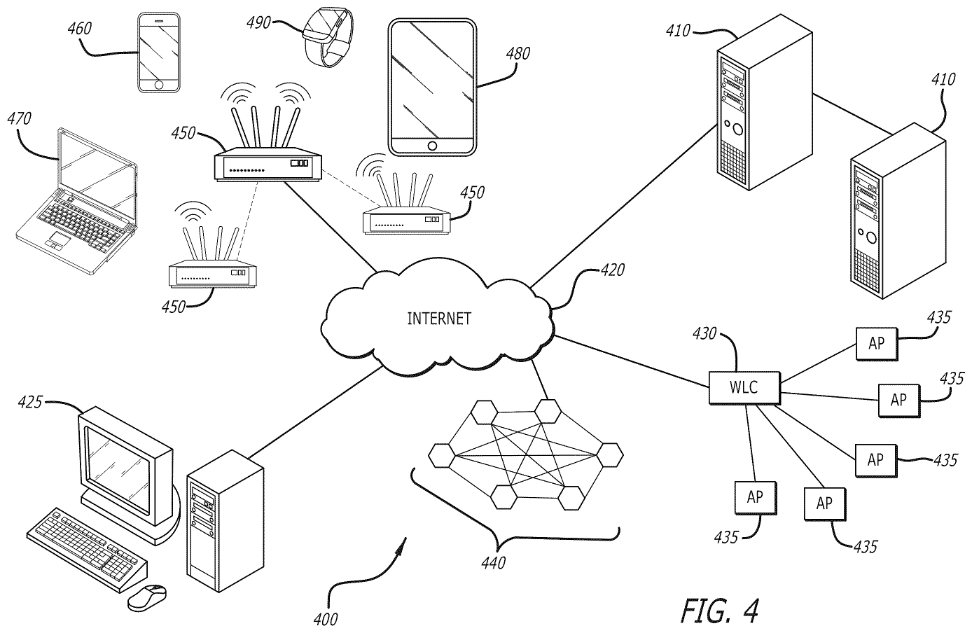

Referring to FIG. 4, a conceptual network diagram of various environments that a material target state programming logic may operate, in accordance with various embodiments of the disclosure is shown. This diagram 400 depicts a plurality of computing devices and network infrastructure components that can be interconnected, representing potential environments where configuration management functionalities, such as those provided by a material target state programming logic, may be deployed or utilized.

In many embodiments, the diagram 400 includes components often found in enterprise or data center environments, such as one or more servers 410, a desktop computer 425, and a deployed network 440. In some embodiments, the cloud controller component of the material target state programming logic could be hosted on one of the servers 410, or as a cloud service accessible via the network 420, such as the Internet. A network administrator may use the desktop computer 425 to define or modify a network target state, which can serve as input to the controller. The deployed network 440, depicted abstractly, could represent a complex network fabric, such as the leaf-spine architectures described herein, whose switches and routers are the targets of configuration changes applied by the material target state programming logic.

In various embodiments, the diagram 400 also illustrates various access network components whose configuration could be managed by the disclosed systems and methods. These can include devices like wireless access points or home routers 450 that provide network connectivity to end-user devices. Additionally, a wireless LAN controller (WLC 430) managing multiple access points (APs) 435 is shown, representing a centrally managed wireless network. The material target state programming logic could be used to generate and apply a material target state (MTS) to these access network components, for example, to update firmware, modify quality of service policies, or apply new security settings.

In certain embodiments, a variety of end-user devices are shown connecting through the access network components, including a cellular phone 460, a laptop computer 470, a portable tablet or smartphone 480, and a wearable computing device 490. The actions of these devices, such as connecting to the network or utilizing certain applications, may trigger a need for network reconfiguration. For instance, the connection of many new devices might prompt an administrator to adjust the network target state, causing the material target state programming logic to generate and apply a new MTS to the WLC 430 or a router 450 to re-allocate network resources.

In some embodiments, the environment depicted in FIG. 4 illustrates the various deployment models for the material target state programming logic. In a remote or centralized cloud model, a controller hosted on one of the servers 410 could manage the configuration of all network elements, such as the deployed network 440 and the WLC 430. The logic is also inherently distributed, as an agent component of the logic may reside on each managed device to receive and execute the MTS. In another embodiment, the system could be deployed in a more localized or on-premises model, where an administrator uses the desktop computer 425 to manage a local controller on one of the servers 410 that in turn configures the deployed network 440.

Although a specific embodiment for various network environments and devices is discussed with respect to FIG. 4, any of a variety of systems and device arrangements may be utilized in accordance with various embodiments. For example, the material target state programming logic could be hosted on one of the servers 410 and used to apply a new security configuration as an MTS to the WLC 430 in response to a newly connected end-user device, such as the cellular phone 460. The elements depicted in FIG. 4 may also be interchangeable with other elements of FIGS. 1-3 and 5-10 as required to realize a particularly desired embodiment.

Referring to FIG. 5, a conceptual timing diagram for programming a switch with material target states via a cloud controller in accordance with various embodiments of the disclosure is shown. The timing diagram 500 illustrates a sequence of interactions between a cloud controller 510, a switch config agent 520, and one or more local switch daemons 530. In certain embodiments, this process demonstrates a hierarchical approach to network management, where abstract network-wide goals may be translated into specific, actionable configurations at the device level.

In many embodiments, the process can begin with a first interaction 511, where the cloud controller 510 may be configured to determine a network target state and generate a material target state based on the network target state. The network target state (NTS) may represent a desired configuration or operational state across an entire network, and the cloud controller 510 can translate this abstract target state into a specific material target state (MTS) for an individual device.

In a number of embodiments, after generating the MTS, the cloud controller 510 may be configured to transmit the material target state in a second interaction 512. As depicted, the MTS may be transmitted to the switch config agent 520. From the perspective of the switch config agent 520, this action may correspond to its function to receive a material target state from the cloud controller 510.

In more embodiments, the switch config agent 520 can initiate a programming sequence associated with the material target state and execute individual configuration operations on each local switch daemon 530 in a third interaction 521. The local switch daemons 530 can be software components running on the switches that directly manage the switch's configuration and operational state. By programming the MTS onto these daemons, the switches may be updated to align with the desired network-wide configuration.

In further embodiments, the switch config agent 520 may be configured to receive a programming outcome report from the local switch daemons 530, compile a programming status report, and transmit the programming status report to the cloud controller 510 in a fourth interaction 531. Concurrently, the cloud controller 510 may be configured to receive a status report associated with the material target state, which can allow it to verify that the device has achieved the correct state.

Although a specific embodiment for a conceptual timing diagram for programming a switch with material target states via a cloud controller for carrying out the various steps, processes, methods, and operations described herein is discussed with respect to FIG. 5, any of a variety of systems and/or processes may be utilized in accordance with embodiments of the disclosure. For example, if the programming of the MTS fails at the local switch daemons 530, the switch config agent 520 could report a failure instead of a success, which could trigger a rollback procedure orchestrated by the cloud controller 510. The elements depicted in FIG. 5 may also be interchangeable with other elements of FIGS. 1-4 and 6-10 as required to realize a particularly desired embodiment.

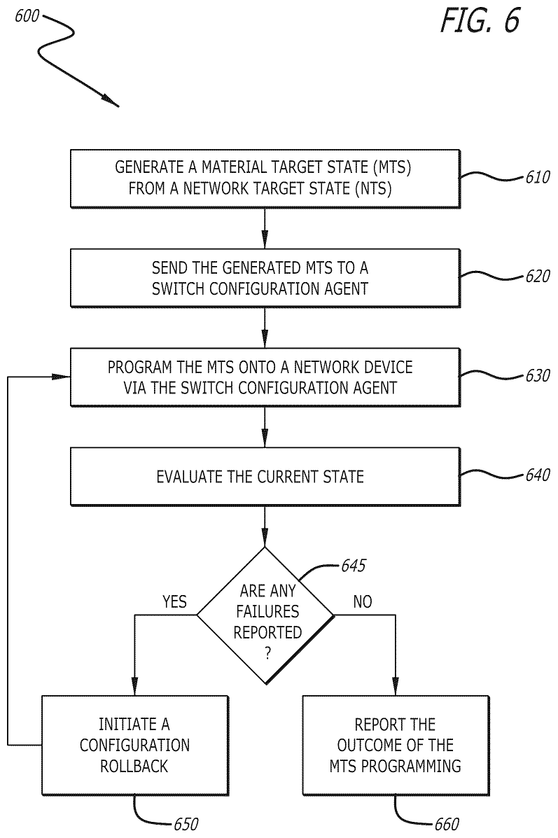

Referring to FIG. 6, a flowchart depicting a process for managing a material target state programming sequence, in accordance with various embodiments of the disclosure is shown. In many embodiments, the process 600 can generate a material target state (MTS) from a network target state (NTS) (block 610). The NTS may be determined automatically based on dynamic network conditions, or it may be defined manually by a network administrator. In certain embodiments, the generated MTS can be a declarative configuration file, while in some other embodiments, the MTS may comprise a procedural script for configuring a network device, particularly for operating systems that lack transactional configuration capabilities.

In a number of embodiments, the process 600 can send the generated MTS to a switch configuration agent (block 620). For example, the transmission may be initiated as a “push” operation from a cloud controller where the logic resides. In some alternative embodiments, the switch configuration agent on a network device could be configured to periodically poll a controller to request or “pull” a new or updated MTS.

In more embodiments, the process 600 can program the MTS onto a network device via the switch configuration agent (block 630). This programming can involve the agent executing individual configuration operations on one or more local daemons of the device. It is also contemplated that, in certain embodiments, the agent may deliver the entire MTS to a native configuration management service on the device, which then handles the application of the state changes.

In further embodiments, the process 600 can evaluate the current state (block 640). The evaluation may comprise the switch configuration agent receiving a programming outcome report from the local daemons it instructed. In some embodiments, the evaluation could involve the agent actively querying the device's configuration databases or operational state after the programming attempt to verify that the intended changes were applied correctly.

In additional embodiments, the process 600 can determine if any failures are reported (block 645). If it is determined that no failures are reported, the process 600 can report the outcome of the MTS programming (block 660). However, if it is determined that one or more failures are reported, the process 600 can initiate a configuration rollback (block 650).

In still more embodiments, the process 600 can initiate a configuration rollback (block 650). Initiating the rollback may involve a cloud controller generating a new rollback MTS and transmitting it to the switch configuration agent for execution. After a rollback is initiated, some embodiments of the process 600 may again program the MTS onto a network device via the switch configuration agent (block 630), where the MTS being programmed is the new rollback MTS.

In yet further embodiments, the process 600 can report the outcome of the MTS programming (block 660). The report can be a simple success notification that is transmitted from the switch configuration agent to a cloud controller. In some embodiments, the report may be a more comprehensive status update that includes performance metrics, configuration checksums, or other validation data, even in the case of a successful programming operation.

Although a specific embodiment for a process for managing a material target state programming sequence for carrying out the various steps, processes, methods, and operations described herein is discussed with respect to FIG. 6, any of a variety of systems and/or processes may be utilized in accordance with embodiments of the disclosure. For example, the failures reported could be syntax errors in the material target state, or they could be device-specific resource limitations that prevent a configuration from being applied. The elements depicted in FIG. 6 may also be interchangeable with other elements of FIGS. 1-5 and 7-10 as required to realize a particularly desired embodiment.

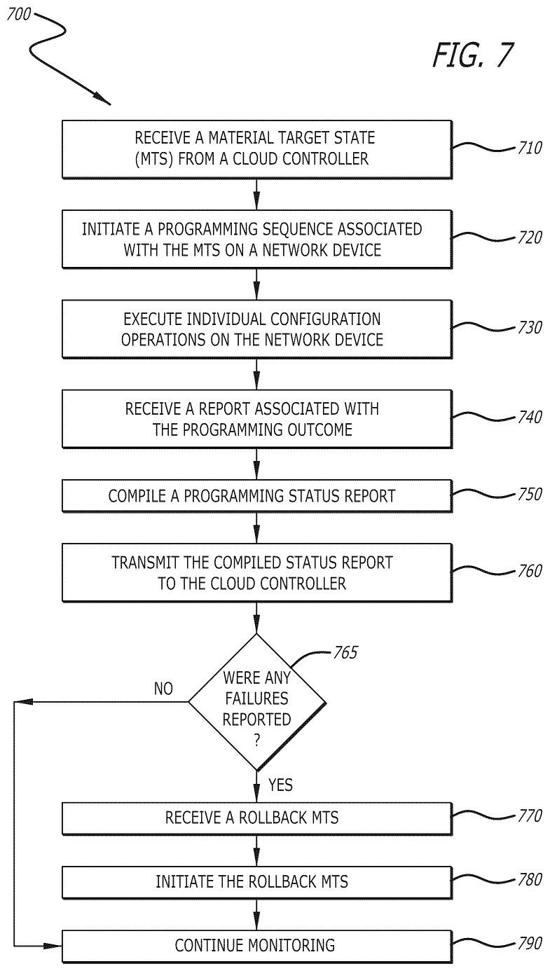

Referring to FIG. 7, a flowchart depicting a process for executing material target state programming, in accordance with various embodiments of the disclosure is shown. In many embodiments, the process 700 can receive a material target state (MTS) from a cloud controller (block 710). The MTS may be received in response to a direct “push” transmission from the cloud controller. In some alternative embodiments, the agent implementing the process could receive the MTS after polling the controller and discovering that a new or updated configuration is available for the device.

In a number of embodiments, the process 700 can initiate a programming sequence associated with the MTS on a network device (block 720). Initiating the sequence may involve parsing the MTS to determine the individual steps of execution, which may be particularly applicable if the MTS comprises a procedural script. In certain embodiments, the initiation could involve performing pre-configuration checks on the network device to ensure it is in a state ready to accept the new configuration changes.

In more embodiments, the process 700 can execute individual configuration operations on the network device (block 730). For instance, the operations could be executed by an on-device agent issuing commands directly to one or more local daemons of the device. It is also contemplated that the execution could involve applying a batch of non-conflicting operations in parallel to potentially speed up the overall programming process.

In further embodiments, the process 700 can receive a report associated with the programming outcome (block 740). The report could be an immediate status code, such as a success or error code, received from a local daemon after each individual configuration operation is executed. In some embodiments, the report could be a more comprehensive diagnostic log generated by a device subsystem in response to a configuration attempt.

In additional embodiments, the process 700 can compile a programming status report (block 750). Compiling the report may involve aggregating the multiple individual outcome reports received during execution into a single, comprehensive status message for the entire MTS application. In certain embodiments, the compilation may also include adding contextual information from the agent performing the process, such as timestamps or software version details.

In still more embodiments, the process 700 can transmit the compiled status report to the cloud controller (block 760). The report could be transmitted over a secure communication channel previously established between the on-device agent and the cloud controller. It is also contemplated that the transmission could be queued by the agent if connectivity to the controller is temporarily unavailable and sent once the connection is re-established.

In yet further embodiments, the process 700 can determine if any failures were reported (block 765). If it is determined that one or more failures were reported, the process 700 can then receive a rollback MTS (block 770). However, if it is determined that no failures were reported, the process 700 can continue monitoring (block 790).

In still additional embodiments, the process 700 can receive a rollback MTS (block 770). The rollback MTS can be generated by the cloud controller in direct response to the failure report sent by the agent. In some embodiments, the rollback MTS may contain operations designed to revert only the specific configuration changes that failed, while in other embodiments, it may contain a full configuration to return the device to a previously known-good state.

In yet more embodiments, the process 700 can initiate the rollback MTS (block 780). Initiating the rollback could involve the agent executing the rollback operations in a manner similar to how it executed the original MTS operations. In certain embodiments, initiating the rollback may require placing the device into a special maintenance or safe configuration mode before applying the rollback changes.

In numerous embodiments, the process 700 can continue monitoring (block 790). Continuing to monitor could involve the agent entering a standby or idle state where it awaits a new MTS from the cloud controller. In some embodiments, the monitoring may involve periodically checking the health of local daemons or the device's configuration to detect any unsolicited changes or configuration drifts from the last successfully applied state.

Although a specific embodiment for a process for executing material target state programming for carrying out the various steps, processes, methods, and operations described herein is discussed with respect to FIG. 7, any of a variety of systems and/or processes may be utilized in accordance with embodiments of the disclosure. For example, the material target state and status reports could be transmitted between the cloud controller and the agent using a secure, streaming protocol. The elements depicted in FIG. 7 may also be interchangeable with other elements of FIGS. 1-6 and 8-10 as required to realize a particularly desired embodiment.

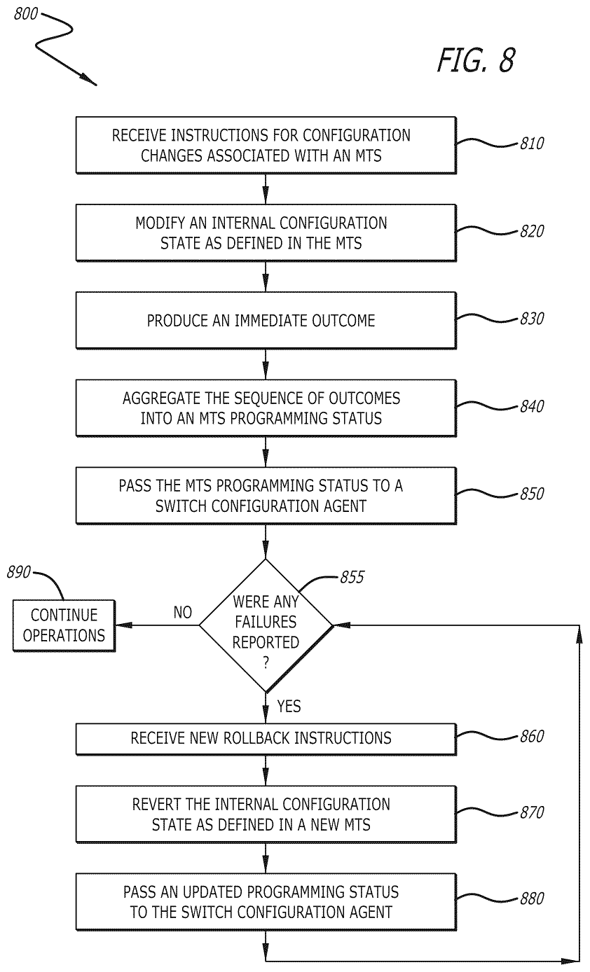

Referring to FIG. 8, a flowchart depicting a process for applying configuration changes based on a material target state, in accordance with various embodiments of the disclosure is shown. In many embodiments, the process 800 can receive instructions for configuration changes associated with an MTS (block 810). The instructions could be received by one or more local daemons of a network device from an on-device switch configuration agent. In some embodiments, the instructions may represent a single command, while in other embodiments, they may be part of a larger procedural script contained within the MTS.

In a number of embodiments, the process 800 can modify an internal configuration state as defined in the MTS (block 820). The modification could involve writing to a configuration database, changing an operational parameter in memory, or reconfiguring a hardware component of the device. It is contemplated that, in certain embodiments, this modification may be part of an atomic transaction to ensure consistency, if the underlying device operating system supports such a feature.

In more embodiments, the process 800 can produce an immediate outcome (block 830). The outcome could be a simple success or failure code that is returned by a local daemon after it attempts to modify the internal configuration state. In some alternative embodiments, the outcome may be a more detailed diagnostic message that provides context about why a specific configuration operation succeeded or failed.

In further embodiments, the process 800 can aggregate the sequence of outcomes into an MTS programming status (block 840). The aggregation could be performed by a specific local daemon that is tasked with overseeing the programming sequence on the device. In certain embodiments, the aggregation could be a logical process where multiple outcomes from different daemons are collected and combined into a single, cohesive status update for the entire MTS application.

In additional embodiments, the process 800 can pass the MTS programming status to a switch configuration agent (block 850). The status could be passed using an inter-process communication (IPC) mechanism on the network device. In some embodiments, the status may be written to a shared memory location or a temporary file that the switch configuration agent is configured to read.

In still more embodiments, the process 800 can determine if any failures were reported (block 855). If it is determined that one or more failures were reported in the MTS programming status, the process 800 can then receive new rollback instructions (block 860). However, if it is determined that no failures were reported, the process 800 can continue operations (block 890).

In yet further embodiments, the process 800 can receive new rollback instructions (block 860). The rollback instructions could be received by local daemons from the on-device switch configuration agent after that agent receives a new rollback MTS from a cloud controller. In some embodiments, the instructions may command a full reversion of the device's configuration to a prior state or may specify targeted removals of only the configurations that failed to apply correctly.

In still additional embodiments, the process 800 can revert the internal configuration state as defined in a new MTS (block 870). Reverting the state could involve deleting newly added configuration lines or restoring previous values for modified parameters. In certain embodiments, the reversion may involve rebooting a specific subsystem of the device to ensure the rollback changes take effect cleanly and completely.

In yet more embodiments, the process 800 can pass an updated programming status to the switch configuration agent (block 880). The updated status may reflect the outcome of the rollback attempt, such as whether the reversion of the internal configuration state was successful. This status may be passed using the same mechanisms as the original programming status, such as IPC or shared memory.

In numerous embodiments, the process 800 can continue operations (block 890). Continuing operations could mean the device's local daemons return to a normal or idle state, having successfully applied a new configuration and reported this success. In certain embodiments, continuing operations could involve the device signaling its readiness to receive a new set of configuration instructions from the agent or controller.

Although a specific embodiment for a process for applying configuration changes based on a material target state for carrying out the various steps, processes, methods, and operations described herein is discussed with respect to FIG. 8, any of a variety of systems and/or processes may be utilized in accordance with embodiments of the disclosure. For example, the immediate outcome produced may include a detailed error log specifying which hardware resource was unavailable, leading to a configuration failure. The elements depicted in FIG. 8 may also be interchangeable with other elements of FIGS. 1-7 and 9-10 as required to realize a particularly desired embodiment.

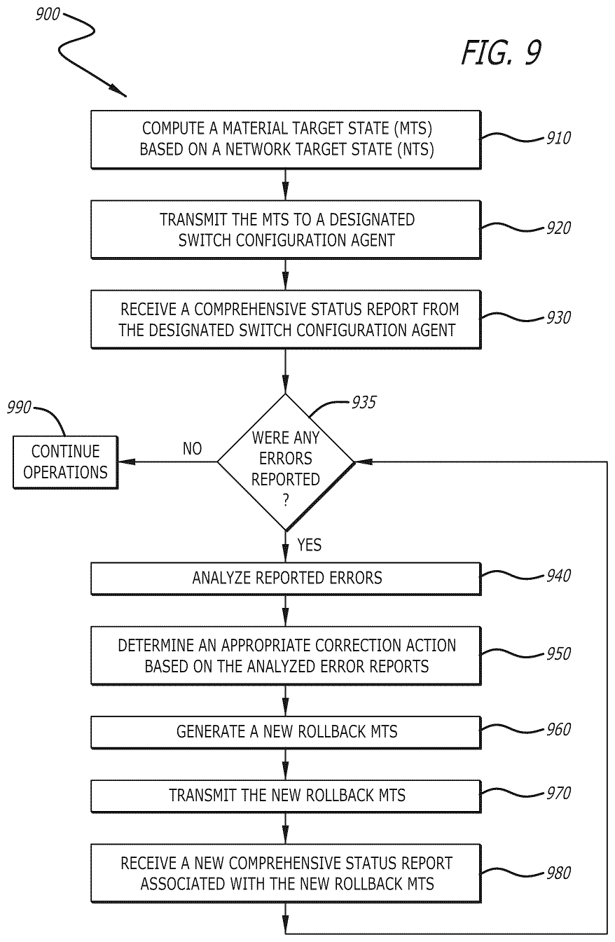

Referring to FIG. 9, a flowchart depicting a process for orchestrating a material target state deployment and rollback, in accordance with various embodiments of the disclosure is shown. In many embodiments, the process 900 can compute a material target state (MTS) based on a network target state (NTS) (block 910). The computation may be performed by a cloud controller, where the NTS could be a high-level policy defined by an administrator or determined automatically. In certain embodiments, the computed MTS may comprise a procedural script designed for a specific network device operating system.

In a number of embodiments, the process 900 can transmit the MTS to a designated switch configuration agent (block 920). The transmission can occur over a secure communication network, such as the internet. In some embodiments, where a change in the NTS affects multiple devices, the MTS could be transmitted to designated agents on each of the affected devices in a network fabric.

In more embodiments, the process 900 can receive a comprehensive status report from the designated switch configuration agent (block 930). The status report could be received asynchronously after the agent completes its attempt to program the MTS. The comprehensive report may include aggregated outcomes from multiple individual configuration operations that were performed by the agent.

In further embodiments, the process 900 can determine if any errors were reported (block 935). If it is determined that one or more errors were reported in the status report, the process 900 can then analyze the reported errors (block 940). However, if it is determined that no errors were reported, the process 900 can continue operations (block 990).

In additional embodiments, the process 900 can analyze reported errors (block 940). The analysis can involve determining if the error was due to a translation from the NTS to the MTS, or a legitimate fault with the device itself. It is also contemplated that the analysis may involve correlating the error with historical error data for that device type to identify patterns.

In still more embodiments, the process 900 can determine an appropriate correction action based on the analyzed error reports (block 950). The corrective action could be to generate and issue a rollback MTS. In some embodiments, the determined action might be to retry the original MTS transmission after a waiting period, particularly if the error was determined to be transient in nature.

In yet further embodiments, the process 900 can generate a new rollback MTS (block 960). The rollback MTS could be generated to revert the device configuration to its state before the failed MTS was attempted. In some alternative embodiments, the rollback MTS could be designed to put the device into a minimal, known-good safe state rather than executing a full reversion of all recent changes.

In still additional embodiments, the process 900 can transmit the new rollback MTS (block 970). The rollback MTS can be transmitted to the same switch configuration agent that reported the original failure. In some cases where a failure on one device impacts the entire fabric, the rollback MTS might be transmitted to agents on multiple devices in the fabric to ensure consistency.

In yet more embodiments, the process 900 can receive a new comprehensive status report associated with the new rollback MTS (block 980). This new report can allow the process to verify that the rollback action was successful and that the device is in a stable, known-good state. The report could be processed using the same logic that processed the original status report, creating a closed-loop management system for configuration changes.

In numerous embodiments, the process 900 can continue operations (block 990). Continuing operations could mean a controller implementing the process enters an idle state, awaiting the next NTS change or status update from a managed device. In certain embodiments, this could involve logging the successful MTS application and archiving the relevant state data for auditing or future reference.

Although a specific embodiment for a process for orchestrating a material target state deployment and rollback for carrying out the various steps, processes, methods, and operations described herein is discussed with respect to FIG. 9, any of a variety of systems and/or processes may be utilized in accordance with embodiments of the disclosure. For example, the appropriate correction action determined may not be a rollback, but instead could be to generate a modified MTS that is designed to work around the reported device fault. The elements depicted in FIG. 9 may also be interchangeable with other elements of FIGS. 1-8 and 10 as required to realize a particularly desired embodiment.

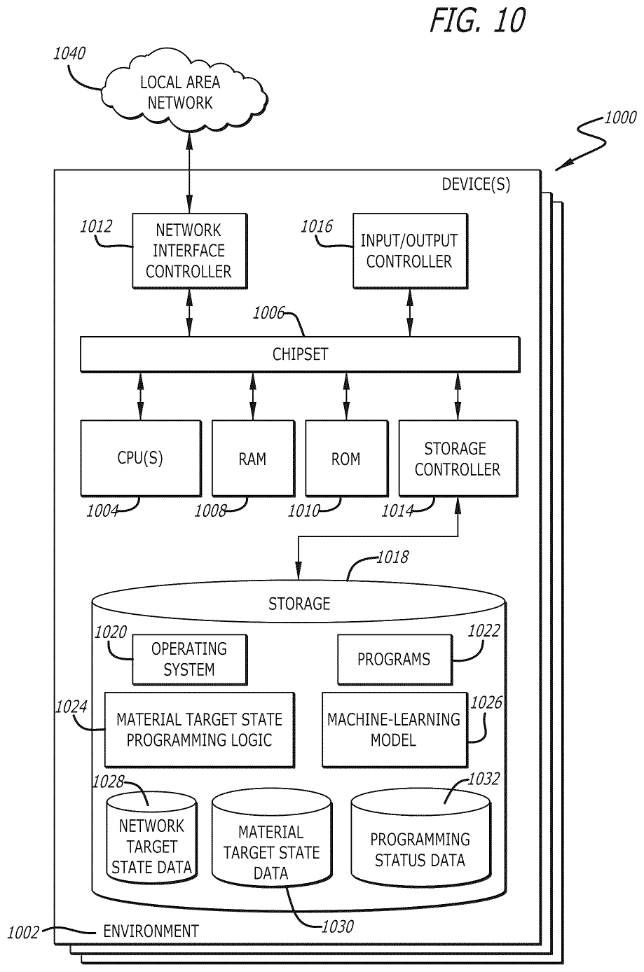

Referring to FIG. 10, a conceptual block diagram of a device 1000 suitable for configuration with a material target state programming logic 1024, in accordance with various embodiments of the disclosure is shown. The embodiment of the conceptual block diagram depicted in FIG. 10 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many non-limiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (RAM 1008), which can be used as the main memory in the device 1000 in some embodiments. The chipset 1006 can further be configured to provide an interface to a computer-readable storage medium such as a read-only memory (ROM 1010) or non-volatile RAM (NVRAM) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (NIC 1012), which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022, network target state data 1028, material target state data 1030, and programming status data 1032. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by a device 1000 or multiple. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as applications 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-7. In certain embodiments, the device 1000 can also include computer-readable storage media having instructions stored thereupon for performing any of the other computer-implemented operations described herein.

In many embodiments, the material target state programming logic 1024 may be a set of instructions that, when executed by one or more processors 1004, can carry out the various processes and operations described herein. The functionality of the material target state programming logic 1024 can be distributed across multiple devices in a network. For example, when operating on a central device such as a cloud controller, the material target state programming logic 1024 may be configured to determine a network target state and subsequently generate a material target state based on that network target state. The generated material target state may comprise a procedural script for configuring a network device.

In further embodiments, when the material target state programming logic 1024 is operating on a network device, such as within a switch configuration agent, it may be configured to receive a material target state. Upon receipt, this logic can initiate a programming sequence, execute individual configuration operations, and compile and transmit a programming status report. This distributed nature allows the logic to handle both the high-level orchestration of configuration and the low-level execution and reporting on individual devices. This may include analyzing reported errors and orchestrating rollbacks through the generation of a new rollback material target state to ensure resilience.

In a number of embodiments, the network target state data 1028 can represent the high-level, abstract desired configuration or operational state for a network or a subset of its devices. This data may serve as the primary input for the material target state programming logic 1024 to begin the configuration process. In this way, the network target state data 1028 can act as the authoritative source of truth for what the network's overall state should be, as defined by a network administrator or a higher-level automation system.

In some embodiments, the network target state data 1028 may contain high-level policies, tenant requirements, service level agreements, or desired connectivity models rather than specific, low-level device commands. For example, the data may specify that a certain group of devices should be part of a particular virtual network, without specifying the exact command-line interface (CLI) commands required to implement that on each device. This data may be primarily stored and processed on a central controller device, where it can be modified or updated to drive changes across the managed network fabric.

In various embodiments, the material target state data 1030 can comprise the concrete, device-specific configuration instructions generated by the material target state programming logic 1024 based on the network target state data 1028. This data may be the artifact that is transmitted from a central controller to the on-device agents for execution. The material target state data 1030 effectively bridges the gap between the abstract intent defined in the network target state data 1028 and the actual commands that a network device can understand and apply.

In certain embodiments, the content of the material target state data 1030 can vary based on the target device. For instance, the data may be a declarative configuration file for some devices, while for other devices with different operating systems, it may be a procedural script that must be executed sequentially. This data type may also include any rollback material target state that is generated by the logic. A rollback material target state may contain the necessary operations to revert an internal configuration state of the device to a previous state in response to a programming failure.

In additional embodiments, the programming status data 1032 can consist of the feedback information generated by an on-device agent after it attempts to apply the material target state data 1030. This data is transmitted from the agent back to the central controller to report the outcome of the programming sequence. The purpose of the programming status data 1032 is to provide a closed feedback loop, allowing the controller to track the state of its managed devices and verify whether configuration changes were successful.

In more embodiments, the programming status data 1032 can range from a simple success or failure notification to a comprehensive report. A comprehensive report may comprise the aggregation of one or more outcomes received in response to the execution of the individual configuration operations. This detailed data is crucial for the controller to determine the presence of one or more reported errors and to analyze those errors to decide on corrective actions. For example, the data could include specific error codes or diagnostic messages that help the controller diagnose whether a failure was due to a translation error or a device fault.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, input/output controllers 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

Finally, in numerous additional embodiments, data may be processed into a format usable by one or more machine-learning models 1026 (e.g., feature vectors), and or other pre-processing techniques. The one or more machine-learning models 1026 may be any type of machine-learning model, such as supervised models, reinforcement models, and/or unsupervised models. The one or more machine-learning models 1026 may include one or more of linear regression models, logistic regression models, decision trees, Naïve Bayes models, neural networks, k-means cluster models, random forest models, and/or other types of models.

In some embodiments, one or more machine-learning models 1026 could be utilized by the material target state programming logic 1024 to enhance the configuration management process. For example, one or more machine-learning models 1026 could be trained on programming status data 1032 and material target state data 1030. The model could learn to predict the likelihood of a given MTS failing on a particular device type or under certain network conditions, allowing the logic to flag potentially risky configurations before they are transmitted.

In certain other embodiments, one or more machine-learning models 1026 could be applied to the error analysis process. It may be configured to analyze complex failure patterns from the programming status data 1032 to diagnose root causes more accurately than simple rule-based logic could. In a more advanced embodiment, a machine learning model could be used to suggest modifications to the network target state data 1028 to optimize network performance or stability based on observed traffic patterns and device health metrics collected from across the network fabric.

In summary, devices, networks, systems, methods, and processes for dynamically proxying traffic between interconnects of devices in a fabric are described herein. A communication network may include multiple switches, including gateway switches and non-gateway switches. Each switch can run a proxy agent for each port of the switch and for each link on each port. The switch may proxy data traffic within the communication network by utilizing the proxy agent. A non-gateway switch can send a connection request to a gateway switch to connect to an external cloud controller. The gateway switch may proxy the connection request to the external cloud controller and receive a session cookie. The non-gateway switch can establish a logical connection with the external cloud controller based on the session cookie.

Although a specific embodiment for a device suitable for configuration with an material target state programming logic 1024 for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor; and
a memory communicatively coupled to the processor, wherein the memory comprises a material target state programming logic that is configured to:
receive a material target state;
initiate a programming sequence associated with the material target state;
execute individual configuration operations;
receive a programming outcome report;
compile a programming status report; and
transmit the programming status report.

2. The device of claim 1, wherein the material target state programming logic is further configured to determine a presence of failures with the programming status report.

3. The device of claim 2, wherein, in response to determining the presence of failures within the programming status report, the material target state programming logic is further configured to receive a rollback material target state.

4. The device of claim 3, wherein the material target state programming logic is further configured to initiate the rollback material target state.

5. The device of claim 4, wherein the rollback material target state comprises one or more operations configured to revert an internal configuration state of the device to a previous state.

6. The device of claim 1, wherein the material target state is received from a cloud controller.

7. The device of claim 1, wherein the material target state comprises a procedural script configured to be executed sequentially by the material target state programming logic.

8. The device of claim 1, wherein the individual configuration operations are executed on one or more local daemons of the device.

9. The device of claim 1, wherein compiling the programming status report comprises aggregating one or more outcomes received in response to the execution of the individual configuration operations.

10. The device of claim 1, wherein the programming status report is transmitted to a cloud controller.

11. A device, comprising:
a processor; and
a memory communicatively coupled to the processor, wherein the memory comprises a material target state programming logic that is configured to:
determine a network target state;
generate a material target state based on the network target state;
transmit the material target state;
receive a status report associated with the material target state; and
determine a presence of one or more reported errors within the status report.

12. The device of claim 11, wherein the material target state programming logic is further configured to, in response to the determination of the presence of one or more errors, analyze the one or more reported errors.

13. The device of claim 12, wherein the material target state programming logic is further configured to determine an appropriate corrective action based on the one or more reported errors.

14. The device of claim 13, wherein the material target state programming logic is further configured to generate a rollback material target state based on the appropriate corrective action.

15. The device of claim 14, wherein the material target state programming logic is further configured to transmit the rollback material target state.

16. The device of claim 15, wherein the material target state programming logic is further configured to receive a second status report associated with the transmitted rollback material target state.

17. The device of claim 11, wherein analyzing the one or more reported errors comprises determining if an error was due to a translation from the network target state to the material target state or a fault with a network device.

18. The device of claim 11, wherein the material target state comprises a procedural script for configuring a network device.

19. The device of claim 11, wherein the material target state is transmitted to a switch configuration agent residing on a network device.

20. A method of dynamically programming a material target state, comprising:
determining a network target state;
generating a material target state based on the network target state;
transmitting the material target state;
receiving a status report associated with the material target state; and
determining a presence of one or more reported errors within the status report.
